(19) United States
(12) Patent Application Publication
(10) Pub. No.: US 2010/0045157 A1
(43) Pub. Date: Feb. 25, 2010

(54) Parabolic dish nozzle spark plug

(76) Inventor: Bill Nguyen, Carson, CA (US)

Correspondence Address: BILL NGUYEN, 16536 SANPEDRO ST., CARSON, CA, 90746, US

(21) Appl. No.: 12/229,496

(22) Filed: Aug. 25, 2008

(51) Int. Cl. H01T 13/02

(52) U.S. Cl. 313/143

(57) ABSTRACT

A spark plug having a ground electrode in the shape of a parabolic defined by a dish reflector and a hole at the center of the parabolic dish reflector. An ignitor electrode terminates at its distal end in a round tip disposed in the center hole in spaced-apart relationship with respect to the center hole. An insulative body supports the ignitor electrode with a conductive body supporting the ground electrode. The parabolic dish reflector is joined with the conductive body by a pair of posts so as to define a pair of slots for venting exhaust gasses from the ignition site.

### BACKGROUND OF THE INVENTION

1. Field of the Invention

The present invention relates to the field of spark plugs for internal combustion engines, and more particularly to a novel spark plug having a parabolic dish reflector at its discharge end providing a narrow throat creating more focus and concentrate of a fuel/air mixture than can be gained from conventional spark plugs.

2. Brief Description of the Prior Art

Spark ignition of an air/fuel mixture within a combustion chamber of an internal combustion engine involves the igniting of the mixture by an electric spark, closing a gap between an electrode, providing the spark and a ground electrode. Thus, in general, upon a downward stroke of a piston within a cylinder, the fuel/air mixture enters the combustion chamber from the carburetor or fuel injection system. Additional fuel/air mixture is then blocked-off upon completion of the compression stroke of the piston and simultaneously a spark is emitted across the spark gap causing combustion of the fuel/air mixture. This combustion and the expanding gasses provides the power stroke of the piston.

Problems and difficulties have been encountered with conventional spark plugs which stem primarily from the fact that none have been able to obtain ultimate performance by providing better mixing of the fuel and air together so that better ignition and more uniform and efficient burning is obtained in the combustion chamber. A part of the problem resides in that the surface area of the igniting electrode is limited and, therefore, the life of the igniting electrode as well as the ground electrode is limited and short lived. Furthermore, the spark crossing the gap follows a linear path which again limits ignition and the conductive path between electrodes.

Therefore, a long-standing need has existed to provide a novel spark plug having a maximum discharge area on the igniting electrode and further having a parabolic dish reflector area on the ground electrode so that the spark high-gain focus traveling through the gap is not constricted or restricted as described above.

### SUMMARY OF THE INVENTION

Accordingly, the above problems and difficulties are avoided by the present invention which provides a spark plug having an insulated ignitor electrode, terminating in a round diameter tip that provides the spark is discharged. The spark plug further includes a ground electrode having a parabolic dish reflector with a central opening occupied by the round diameter tip of the ignitor electrode in fixed, spaced-apart relationship. The parabolic dish reflector further includes a parabolic shape and a central through hole and the ignitor electrode are concentrically arranged at the end of the spark plug. The parabolic dish reflector is carried on the end of the spark plug by a pair of posts which separate the parabolic dish reflector from the end of the spark plug by a pair of slots for venting the area upon ignition.

By providing a parabolic dish reflector with a parabolic reflector shape a central opening creates a narrow throat for concentrating the fuel/air mixture faster upon ignition permitting the horizontal slots between the ground electrode and the end of the spark plugs to vent burned gasses.

Therefore, it is among the primary objects of the present invention to provide a parabolic dish reflector spark plug having a parabolic dish reflector shaped face creating a focus area for providing a concentrate of fuel/air mixture in a shorter time in which to cause ignition while burnt gasses are removed from the area in a faster manner by means of venting slots.

Still a further object of the present invention is to provide a spark plug having a ground electrode formed in a parabolic dish reflector shape which provides high frequencies Distribute gain more heat than conventional spark plugs. Another object of the present invention is to provide a parabola dish nozzle spark plug having a ground electrode with a parabolic dish shape in spaced relationship to a round diameter tipped ignitor electrode in order to burn a fuel/air mixture extremely fast so as to provide fuel efficiency and to burn clean.

Still a further object is to provide a spark plug discharging set of electrodes wherein the spark generated by the ignitor electrode passes to the ground electrode which is of a parabolic dish reflector shape so as to burn mixed gasses and which is capable of generating a focus and distribute ignition in a relatively short period of time in order to burn the mixed gasses very quickly whereby power is increased and the burn is clean and fuel efficiency is gained.

### BRIEF DESCRIPTION OF THE DRAWINGS

The features of the present invention which are set forth with particularity in the appended claims. The present invention, both as to its organization and manner of operation, together with further objects and advantages thereof, may best be understood with reference to the following description, taken in connection with the accompanying drawings in which:

FIG. 1 is an enlarged sectional view of a conventional spark plug having an ignitor electrode and a ground electrode;

FIG. 2 is a perspective view of the parabolic dish reflector spark plug incorporating the present invention;

FIG. 3 is an enlarged side elevational view of the electrodes in the spark plug shown in FIG. 2 and partially in section to illustrate components thereof; and

FIG. 4 is a longitudinal sectional view of the spark plug incorporating the present invention and illustrated as installed in a cylinder having a working piston therein.

### DESCRIPTION OF PREFERRED EMBODIMENT

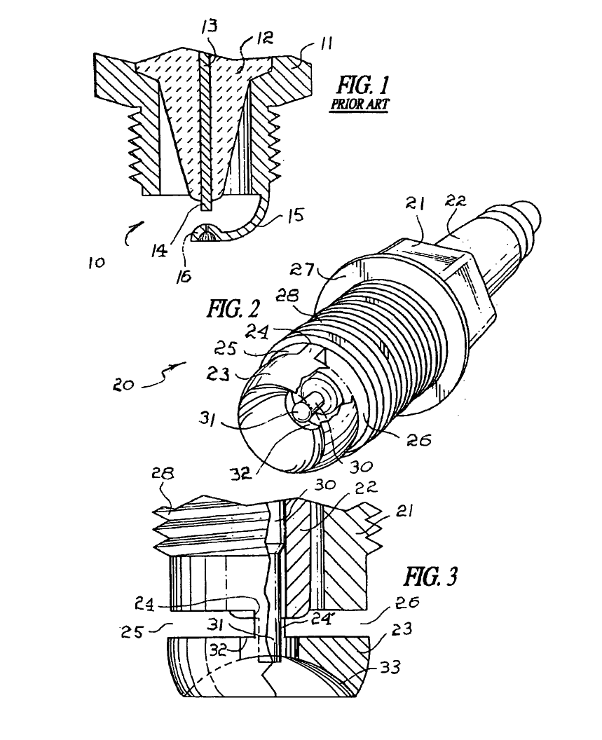

Referring to FIG. 1, a conventional tip of a spark plug is illustrated in the general direction of arrow 10 which includes a body 11 supporting an insulator 12 which, in turn, supports an ignitor electrode 13. It can be seen that the electrode 13 terminates at its distal end in a cylindrical tip 14 and that the tip is in fixed, spaced-apart relationship with respect to a ground electrode 15. The ground electrode 15 terminates at its distal end in a knob 16 which is fixed, spaced-apart relationship with respect to the tip 14 of the ignition electrode. Therefore, a substantial gap is defined between the two electrodes. However, it can be seen that the relative surface area of the electrodes is limited to the cylindrical shape of the tip 14 and the knob 16. Therefore, since only a limited surface area is available, extensive wear and debris build-up occurs rapidly. As the build-up continues, efficiency decreases.

Referring now in detail to FIG. 2, it can be seen that the parabolic dish reflector spark plug incorporating the present invention is indicated in the general direction of arrow 20 and includes an elongated body 21 which supports an insulated inner body 22. The outer body 21 terminates at one end in a parabolic dish reflector head 23 which is joined to the main body by a pair of posts, such as post 24, with the other post of the pair on the opposite side. The pair of posts defines horizontal slots 25 and 26 which serve as venting slots for expanded, ignited gasses. A washer 27 is disposed around the outer body and the outer body further includes a set of threads 28 for threaded attachment with a bore in the cylinder of an engine.

The parabolic dish reflector is a ground electrode, while an ignitor or ignition electrode is indicated by numeral 30 and is supported by the insulator inner body 22. A distal end of the ignitor electrode 30 terminates in a round diameter 31 and is disposed in a central opening 32 of the parabolic dish reflector.

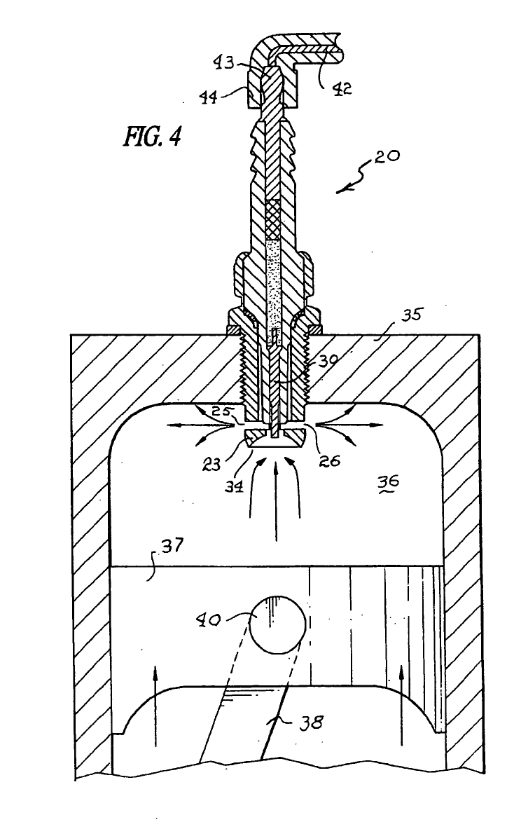

Referring now in detail to FIG. 3, it can be seen that the head 23 includes a rounded, parabolic dish reflector inner surface 33, the ignitor electrode 30 to terminate at the opening 32. Also, it is to be noted that the round diameter tip 31 electrode 30 partially occupies the opening 32 and is disposed in fixed, spaced-apart relationship with respect to the center of the parabolic dish reflector. The inner wall 33 is parabolic dish shape in cross-section configuration, Also, the posts supporting the parabolic dish reflector head to the body 21 are indicated on one side by numeral 24 and at its opposite side by numeral 24′.

Referring now in detail to FIG. 4, it can be seen that the parabolic dish reflector spark plug 20 is threadably mounted on a cylinder 35 so that the spark creating end of the spark plug is within the combustion chamber of the cylinder. A piston 37 is illustrated which is moved up and down within the cylinder by a piston rod 38 having a pivot attachment 40 to the piston.

As fuel is introduced into the piston chamber, fuel and air are mixed within the combustion chamber 36 and compressed on the up-stroke of the piston 37. The compressed fuel/air mixture is ignited by means of an electrical impulse provided by ignition wire 42 which is connected to the ignitor electrode by press fittings 43 and 44.

At the time of the compression cycle, the piston forces the fuel/air mixture to travel through the parabolic dish reflector surface so that the fuel/air mixture enters with a larger volume from the mouth of the parabolic dish while digressing in smaller volume to the smaller or reduced throat at central opening 32. Upon ignition, the exhaust gasses escape from the nozzle via the venting slots 25 and 26 while traveling through the parabolic dish and gathering speed at the throat 32. More mixed gasses concentration provides sensitivity to ignition and prepares for the next ignition or explosion cycle.

At the proper time, the spark plug discharging between the ignitor or central electrode 31 and the ground-parabolic dish 23 burns the mixed gasses so that explosion occurs and generates an enlarged fire jet through the vent slots at great speed. The burned mixed gasses in the cylinder greatly increase power, burn clean, and the engine performs with better fuel efficiency. A reverse flow occurs through vents preparatory to ignition.

Therefore, it can be seen that the parabolic dish providing passageway between the mouth and throat of the opening provides substantial area presented to the round diameter tip 31 for conducting an ignition spark there between. The two electrodes are in spaced-apart relationship and adjustment with respect to centering and coaxial displacement of the ignitor electrode 30 can be achieved by bending the tip with a proper tool. In the prior art illustration of FIG. 1, it is noted that the ground electrode 15 is adjustable by bending, while the ignitor electrode 14 is not pliable nor bendable. While particular embodiments of the present invention have been shown and described, it will be obvious to those skilled in the art that changes and modifications may be made without departing from this invention in its broader aspects and, therefore, the aim in the appended claims is to cover all such changes and modifications as fall within the true spirit and scope of this invention.

What is claimed is:

1. A spark plug for the controlled burning of a fuel/air mixture at a defined burn zone within a combustion chamber in the cylinder of an internal combustion engine comprising: an elongated electronically non-conductive body; an ignitor electrode supported by said non-conductive body and having a distal tip extending into said burn zone; an elongated conductive body surrounding said non-conductive body and having a parabolic dish reflector nozzle immediately adjacent said tip in spaced-apart relationship; at least one post joining said parabolic dish reflector nozzle with said conductive body and to hold said nozzle in spaced-apart relationship with respect to said conductive body to define said burn zone; vent slots provided in said burn zone by said posts for exhausting gasses there-through exteriorly of said parabolic dish nozzle; said parabolic dish reflector nozzle is circular having a parabolic dish reflector inner side wall terminating adjacent said tip in a reduced throat diameter and terminating exteriorly with an enlarged mouth of greater diameter than the diameter of said throat diameter; said side wall constituting a parabolic dish having the reflector surface; said distal tip of said ignitor electrode is round diameter and resides within said throat of said parabolic dish reflector nozzle defining an annular linear entrance leading into said throat; and said ignitor electrode bendable for adjustment with respect to distance from said parabolic dish nozzle with said throat.

2. A spark plug for the controlled burning of a fuel/air mixture at a defined burn zone within a combustion chamber in the cylinder of an internal combustion engine comprising: a non-conductive body; a conductive body supporting said non-conductive body; an ignitor electrode carried by said non-conductive body having an exposed distal tip of rounded configuration; a ground electrode supported by said conductive body and having a parabolic dish nozzle with a frustum-parabolic passageway defined by a parabolic dish reflector inner wall leading from a mouth to a throat partially encircling said distal tip of said ignitor electrode; a pair of posts integrally connecting said non-conductive body with said parabolic dish nozzle to define venting slots between said conductive body and said parabolic dish nozzle; and said mouth commencing with a linear annular opening downwardly merging with a parabolic dish reflector-shaped side wall.
